(19) United States
(12) Patent Application Publication
(10) Pub. No.: US 2019/0205320 A1
(43) Pub. Date: Jul. 4, 2019

(54) SENTENCE SCORING APPARATUS AND PROGRAM

(71) Applicant: KONICA MINOLTA, INC., Tokyo (JP)

(72) Inventor: Kouichi TOMITA, Kawanishi-shi (JP)

(73) Assignee: KONICA MINOLTA, INC., Tokyo (JP)

(21) Appl. No.: 16/212,856

(22) Filed: Dec. 7, 2018

(30) Foreign Application Priority Data
Dec. 28, 2017 (JP) 2017-253009

(51) Int. Cl. G06F 16/31; G06F 17/27; G06F 16/93

(52) U.S. Cl. CPC G06F 16/313; G06F 16/93; G06F 17/2765

(57) ABSTRACT

A sentence scoring apparatus includes a hardware processor that: extracts a sentence from a document having a hierarchical structure; derives a first weight value corresponding to a title of a hierarchical layer above a hierarchical layer to which the sentence extracted by the hardware processor belongs; extracts a keyword included in the sentence; derives a second weight value of the sentence on the basis of the extracted keyword; and determines a weight value of the sentence on the basis of the first weight value and the second weight value.

The entire disclosure of Japanese patent Application No. 2017-253009, filed on Dec. 28, 2017, is incorporated herein by reference in its entirety.

### BACKGROUND

### Technological Field

The present invention relates to a sentence scoring apparatus and a program capable of weighting documents.

### Description of the Related Art

There is a method of text mining that is a method of extracting useful information from a text (sentence). This method can be used to extract a word having a negative meaning such as “failure” for example from the text and make a group. Reading of this extracted text makes it possible to easily make confirmation targeted on useful information alone in the document without reading the entire document.

As a conventional technique of determining a sentence as an extraction target from a document, there is a method of dividing a sentence into words, and performing weighting to the entire sentence by using importance (weight value) of each of words.

Moreover, JP 2009-128967 A discloses a method of determining a noun and a predicate in a document and then performing weighting for each of the words on the basis of expressed content of the predicate with respect to the noun. This method sets a first weight value when a predicate for a specific noun is has a concept expressing a state change, sets a second weight value for a predicate expressing a concept of existence, and sets a third weight value when the predicate expresses a concept of existence in negative.

For example, FIG. 16 illustrates an example of weighting by the method described in JP 2009-128967 A. In comparison between the sentences “the tumor has not expanded” and “no tumor is observed”, “the tumor has not expanded” denies a state change while “no tumor is observed” denies the existence. Even with the same negative sentence, the denial of the state change implicitly indicates the existence of the target, and different weighting is performed accordingly.

Meanwhile, there is a case, in weighting sentences, where it is more preferable to consider factors other than the content of sentences.

FIG. 17 illustrates a state where weighting is applied to document A and document B. Each of documents A and B is formed with two components, namely, a title and a text. While documents A and B have different tides, the same text “analyzing cause of failure in the market” is used in common. In FIG. 17, titles indicate project names. Specifically, document A indicates project AAA with high importance, document B indicates project BBB with low importance. Because Project AAA and Project BBB have different levels of importance, it is desirable to set the importance of the sentence related to the project with higher importance.

Unfortunately, however, the method described in JP 2009-128967 A and the conventional method perform weighting simply on the basis of the content of the sentence with no support of weighting in view of other information in a case of performing weighting on one sentence. Accordingly, document A and document B are weighted, in their text, with the same importance.

### SUMMARY

The present invention is intended to solve the above problem, and an object is to provide a sentence scoring apparatus and a program capable of weighting a sentence in a document having a hierarchical structure in view of information other than the sentence.

To achieve the abovementioned object, according to an aspect of the present invention, a sentence scoring apparatus reflecting one aspect of the present invention comprises a hardware processor that: extracts a sentence from a document having a hierarchical structure; derives a first weight value corresponding to a title of a hierarchical layer above a hierarchical layer to which the sentence extracted by the hardware processor belongs; extracts a keyword included in the sentence; derives a second weight value of the sentence on the basis of the extracted keyword; and determines a weight value of the sentence on the basis of the first weight value and the second weight value.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating an example of a document configuration analysis system according to an embodiment of the present invention;

FIG. 2 is a block diagram illustrating a schematic configuration of a server as a sentence scoring apparatus according to an embodiment of the present invention;

FIG. 3 is a diagram illustrating a state where a sentence is extracted from a document;

FIG. 4 is a diagram illustrating a state where keywords and a title are extracted from sentences, and their weight values;

FIG. 5 is a diagram illustrating a state where scoring of sentence is performed from a keyword and a title;

FIG. 6 is a diagram illustrating an example of how to manage a case where there is a plurality of titles of the same type in the same hierarchical layer;

FIG. 7 is a diagram illustrating a method of detecting a title to be used for scoring in case of scoring in view of simply one type of title;

FIG. 8 is a diagram illustrating a state where matters indicated by a sentence are registered in a scoring history;

FIG. 9 is a diagram illustrating an example of calculating a final score with a weight value according to a duration;

FIG. 10 is a diagram illustrating a state where a completed matter is registered as a scoring history;

FIG. 11 is a diagram illustrating an example of a scoring history in which “completed” is registered;

FIG. 12 is a diagram illustrating coefficients related to the number of recurrence of a matter;

FIG. 13 is a flowchart illustrating a flow of scoring based on keywords and titles;

FIG. 14 is a flowchart illustrating a flow of final scoring by the duration of a matter;

FIG. 15 is a flowchart illustrating a flow of scoring related to recurrence;

FIG. 16 is a diagram illustrating an example of a failure occurring in a case where weighting is performed simply with the content of a text; and

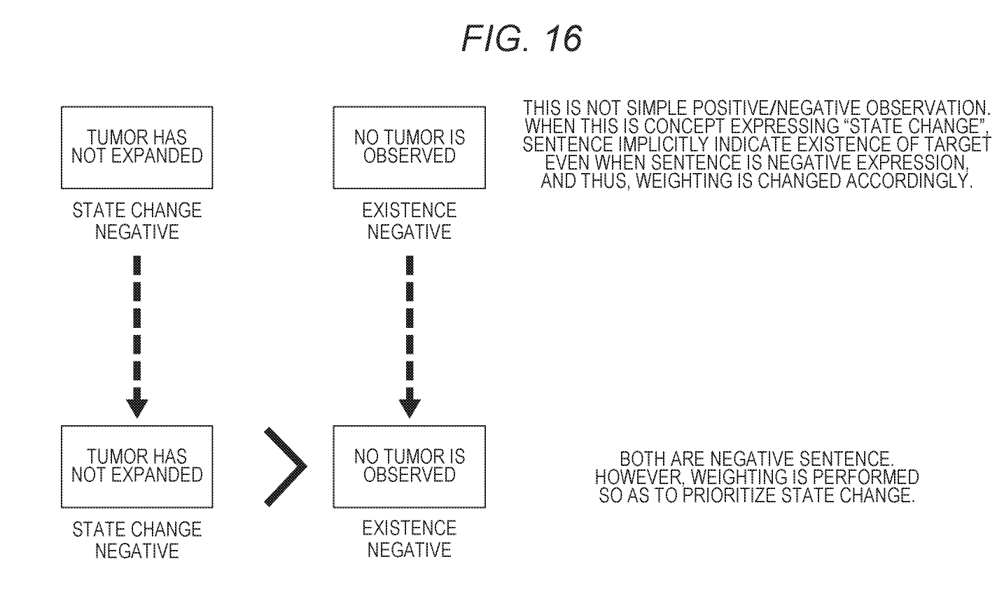

FIG. 17 is a diagram illustrating an example of a case the needs weighting by a duration of a matter.

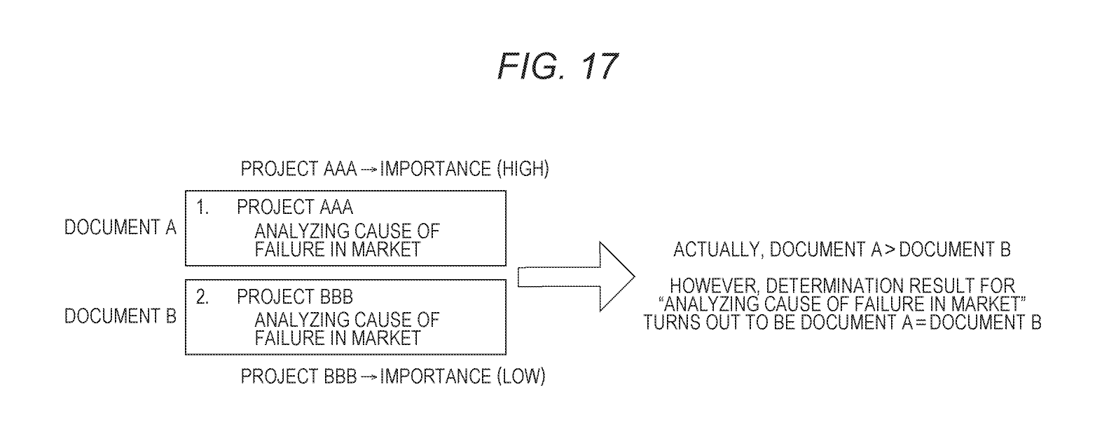

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

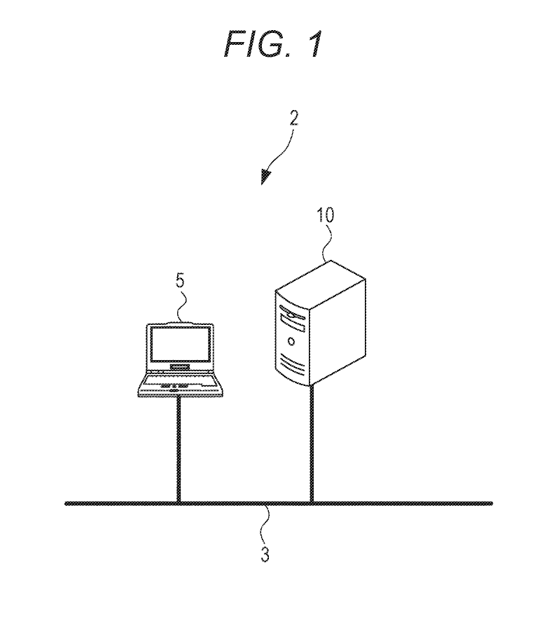

FIG. 1 is a diagram illustrating an example of a document configuration analysis system 2 including a PC 5 according to an embodiment of the present invention. The document configuration analysis system 2 is configured by connecting a server 10 serving as a sentence scoring apparatus according to an embodiment of the present invention, and a PC 5, to a network 3 such as a local area network (LAN).

The PC 5 is a terminal device such as a personal computer used by a user. The PC 5 includes a central processing unit (CPU), a read only memory (ROM), and a random access memory (RAM), and operates on the basis of various programs such as operating system (OS) and application programs. In an embodiment of the present invention, the PC 5 creates and saves a document, inputs a document to the server 10, and requests scoring of a sentence in the input document.

After receiving a document input from the PC 5 and a request for scoring a sentence in the document, the server 10 extracts the sentence from the document and performs scoring. The document to be input to the server 10 is assumed to be a document having a hierarchical structure having classification of a chapter, a section, a subsection, a text, or the like.

In the scoring in the embodiment of the present invention, a keyword is detected from a sentence and a second weight value corresponding to the keyword is derived. Furthermore, a first weight value is derived in accordance with the title of the hierarchical layer above the hierarchical layer to which the sentence belongs. Subsequently, the weight value of the sentence is determined on the basis of the first weight value and the second weight value. The title of the hierarchical layer to which the sentence belongs and the title of the higher hierarchical layer in higher order is likely to include information related to the sentence, such as a theme name, affiliated project name, and phase, for example. Accordingly, by performing scoring not only in view of sentences but also in view of the information, it is possible to perform to achieve scoring that fits actual situation.

In the embodiment of the present invention, scoring is performed in view of the duration of a matter indicated by a sentence. In a case where the content of the sentence is related to solution of a problem and if the duration of the matter (subject matter) indicated by the sentence is long, it is presumed that the current problem cannot be solved easily or shortly. In this case, it is desirable to give high importance to this sentence because of the difficulty in solving the problem. On the contrary, if the duration of a matter indicated by a sentence is short, there is a high possibility that it can be easily solved. In this case, there is less necessity to give a higher importance to the sentence. Therefore, it is possible to perform scoring in accordance with such actual situation as compared with a case where scoring is performed on the basis simply of character strings in the sentence.

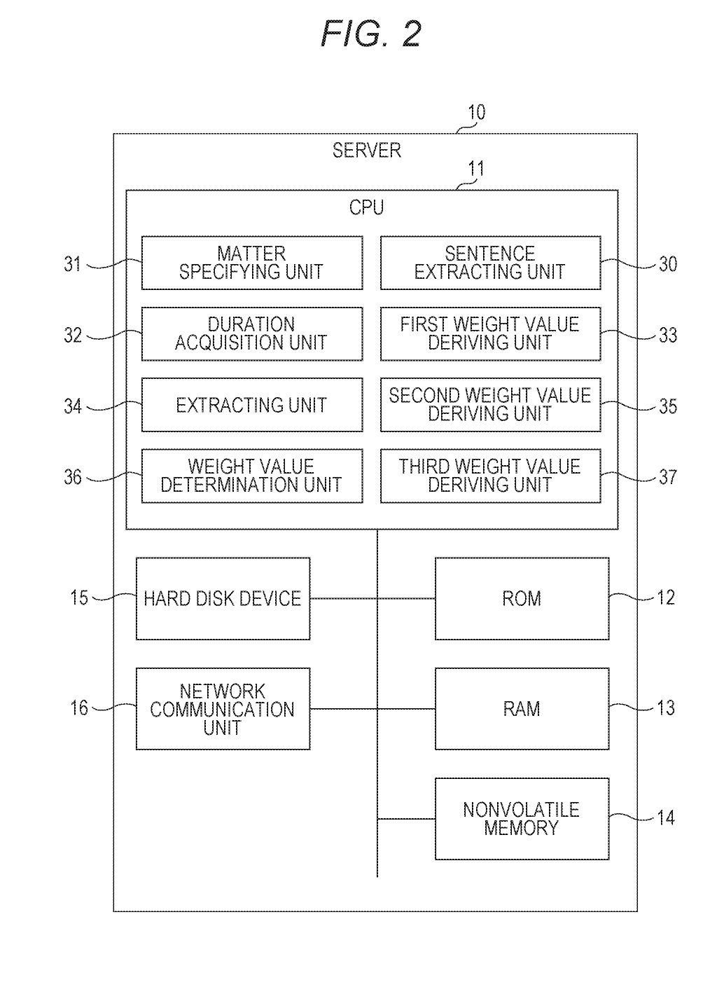

FIG. 2 is a block diagram illustrating a schematic configuration of the server 10. The server 10 includes a central processing unit (CPU) 11 that comprehensively controls the operation of the server 10. The CPU 11 is connected to a read only memory (ROM) 12, a random access memory (RAM) 13, a nonvolatile memory 14, a hard disk device 15, a network communication unit 16, or the like, via a bus.

The CPU 11 executes middleware, application programs or the like on the basis of an OS program. The ROM 12 and the hard disk device 15 store various programs. The CPU 11 executes various types of processing in accordance with these programs, thereby implementing each of functions of the server 10.

The RAM 13 is used as a work memory that temporarily stores various data when the CPU 11 executes processing on the basis of the program, or as an image memory that stores image data.

The nonvolatile memory 14 is a memory (flash memory) that maintains stored content even when the power supply is turned off and it is used for storing various types of setting information or the like. The hard disk device 15 is a large-capacity nonvolatile storage device, and stores various types of programs and data in addition to image data or the like. In the embodiment of the present invention, a document input from the PC 5, a history of the scoring document, each of keywords and its weight value, or the like, are stored.

The network communication unit 16 functions to communicate with the PC 5 and other external devices via the network 3.

In the embodiment of the present invention, the CPU 11 functions as a sentence extracting unit 30 that extracts a sentence from a document having a hierarchical structure, an extracting unit 34 that extracts a keyword included in a sentence, a second weight value deriving unit 35 that derives a second weight value on the basis of the extracted keyword, a first weight value deriving unit 33 that derives a first weight value according to a title of a hierarchical layer above a hierarchical layer to which a sentence belongs, and a weight value determination unit 36 that determines a weight value of the sentence on the basis of the first weight value and the second weight value.

Note that the CPU 11 also functions as a matter specifying unit 31 that specifies a matter indicated by a sentence, a duration acquisition unit 32 that acquires a duration of the matter, a third weight value deriving unit 37 that derives a third weight value of the sentence on the basis of the acquired duration.

In the embodiment of the present invention, the server 10 first extracts a sentence from a document, and then performs scoring of the sentence on the basis of the content of the sentence. In this case, the scoring is performed by using keywords contained in the sentence and titles of the hierarchical layers above the hierarchical layer to which the sentence belongs. Thereafter, the weight value (final score) of the final sentence is calculated by using the weight value based on the duration of the matter indicated by the sentence. Each of processing performed for calculation of the final score will be described.

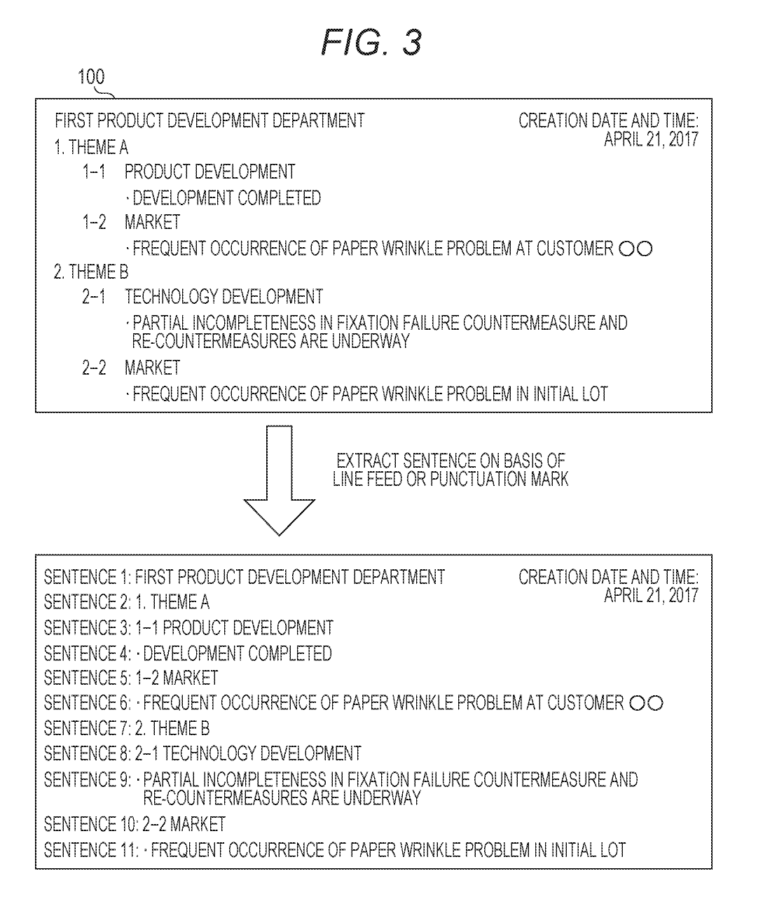

First, a method of extracting a sentence from a document having a hierarchical structure will be described. FIG. 3 illustrates a state where a sentence is extracted from a document. In FIG. 3, existence of a line feed or a punctuation mark is assumed to indicate an end of a sentence and a portion up to that point is extracted as one sentence. The method of extracting sentences from a document is not limited to this.

A document 100 of FIG. 3 is a document having the following hierarchical structure.

First product development department Creation date and time: Apr. 21, 2017

1. Theme A
1-1 Product development
   Development completed
1-2 Market
   Frequent occurrence of paper wrinkle problem at customer ∘∘

2. Theme B
2-1 Technology development
   Partial incompleteness in fixation failure countermeasure and re-countermeasures are underway
2-2 Market
   Frequent occurrence of paper wrinkle problem in initial lot

By dividing this document at each of punctuation marks and line feeds, it is possible to extract the following Sentences 1 to 11.

Sentence 1: First product development department Creation date and time: Apr. 21, 2017

Sentence 2: 1. Theme A

Sentence 3: 1-1 Product development

Sentence 4: Development completed

Sentence 5: 1-2 Market

Sentence 6: Frequent occurrence of paper wrinkle problem at customer ∘∘

Sentence 7: 2. Theme B

Sentence 8: 2-1 Technology development

Sentence 9: Partial incompleteness in fixation failure countermeasure and re-countermeasures are underway

Sentence 10: 2-2 Market

Sentence 11: Frequent occurrence of paper wrinkle problem in initial lot.

The server 10 analyzes the structure of the document when extracting sentences from the document 100. While any method may be used as a method of analyzing the document structure, the method in the embodiment of the present invention determines to which of a chapter, a section, a subsection, or text each of the sentences belongs and analyzes their hierarchical structures on the basis of the indentation, assignment method of serial numbers, or the like.

Next, the server 10 detects keywords and titles as extraction targets related to scoring in each of the sentences. In the embodiment of the present invention, the server 10 has preliminarily registered character strings to be the keywords and titles as extraction targets. In a case where the registered character string exists in the sentence, the server 10 detects the character string. A weight value is preliminarily set for each of the registered character strings, and the weight value is used for calculating the weight value of a sentence.

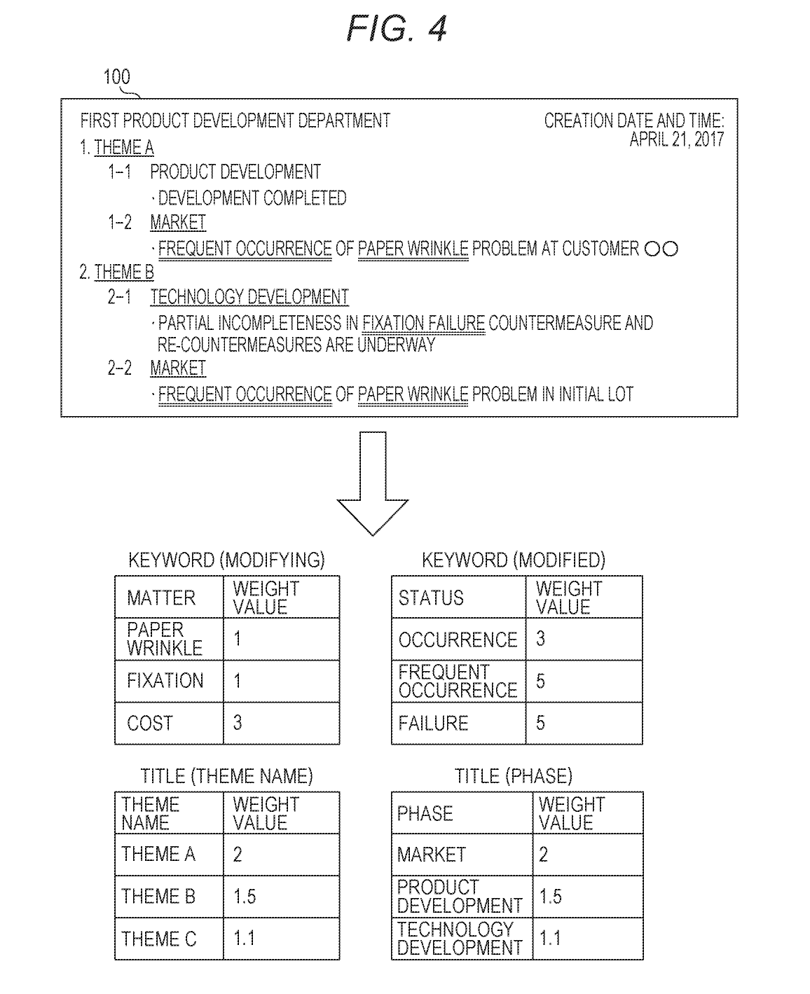

FIG. 4 illustrates keywords and titles as extraction targets and weight values set for these in the document 100. In the document 100 of FIG. 4, a double underline is attached to a keyword and an underline is attached to a title.

In the embodiment of the present invention, a keyword can have a modifying-modified relationship with another keyword, and thus, keywords are classified into a keyword as a subject (keyword (modifying) in the figure) of a succeeding keyword and a keyword as a predicate of the preceding keyword (keyword (modified) in the figure).

In FIG. 4, examples of the keyword (modifying) include “paper wrinkle”, “fixation”, and “cost” while examples of the keyword (modified) include “occurrence”, “frequent occurrence”, and “failure”. In addition, the theme names (theme A, theme B, theme C) and phases (market, product development, technology development) are defined as titles.

In FIG. 4, a weight value is set to each of the character strings to be defined as the keywords and titles as extraction targets as follows.

“Paper wrinkle”→1

“Fixation”→1

“Cost”→3

“Occurrence”→3

“Frequent occurrence”→5

“Failure”→5

“Theme A”→2

“Theme B”→1.5

“Theme C”→1.1

“Market”→2

“Product development”→1.5

“Technology development”→1.1

Next, a method of scoring sentences on the basis of keywords and titles will be described. In the embodiment of the present invention, the server 10 selectively defines a sentence that contains both the keyword (modifying) and the keyword (modified) as a scoring target.

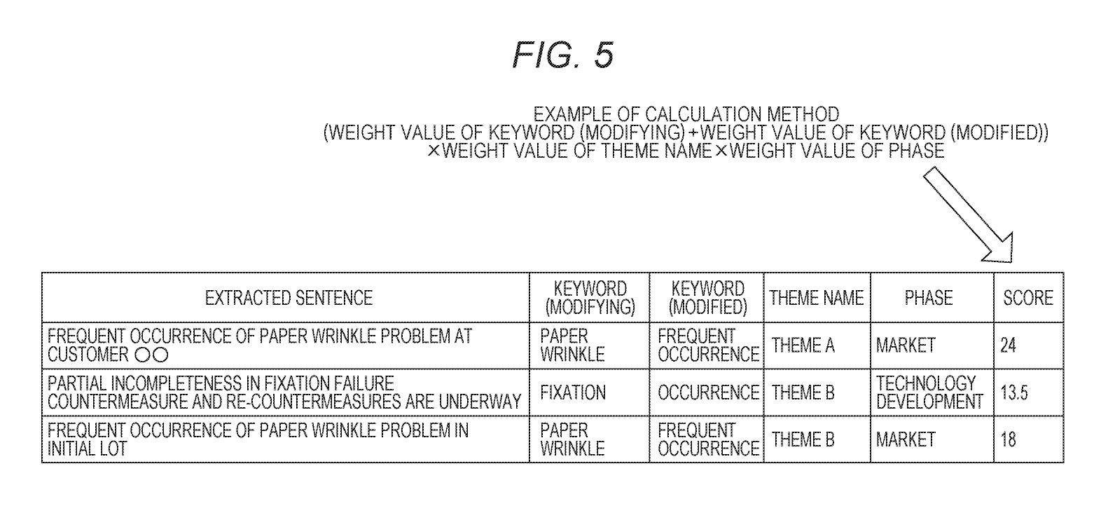

FIG. 5 illustrates an example of scoring a sentence on the basis of the keywords and the titles extracted in FIG. 4. In FIG. 5, scoring is performed for three sentences, namely, sentences 6, 9, and 11 in FIG. 3 each including two keywords having a modifying-modified relationship.

In the embodiment of the present invention, in a case where scoring a sentence, a weight value corresponding to a title of a hierarchical layer above the hierarchical layer to which the sentence belongs is to be used for scoring the sentence. Although the calculation formula here is

“weight value of(keyword(modifying)+weight value of keyword(modified))×weight value of title(theme name)×weight value of title(phase)”

the calculation formula at the time of scoring is not limited to this, and other calculation formulas may be used.

Sentence 6 contains a keyword (subject) being “paper wrinkle”, and a keyword (received) being “frequent occurrence”, and the titles of the hierarchical layer above the hierarchical layer at which sentence 6 is located are “theme A” and “market”. When the weight values corresponding to these character strings are applied to the above calculation formula, the score would be “24”. By using a similar method, sentence 9 is calculated to be the scores of “13.5” and sentence 11 is calculated to be the score of “18”.

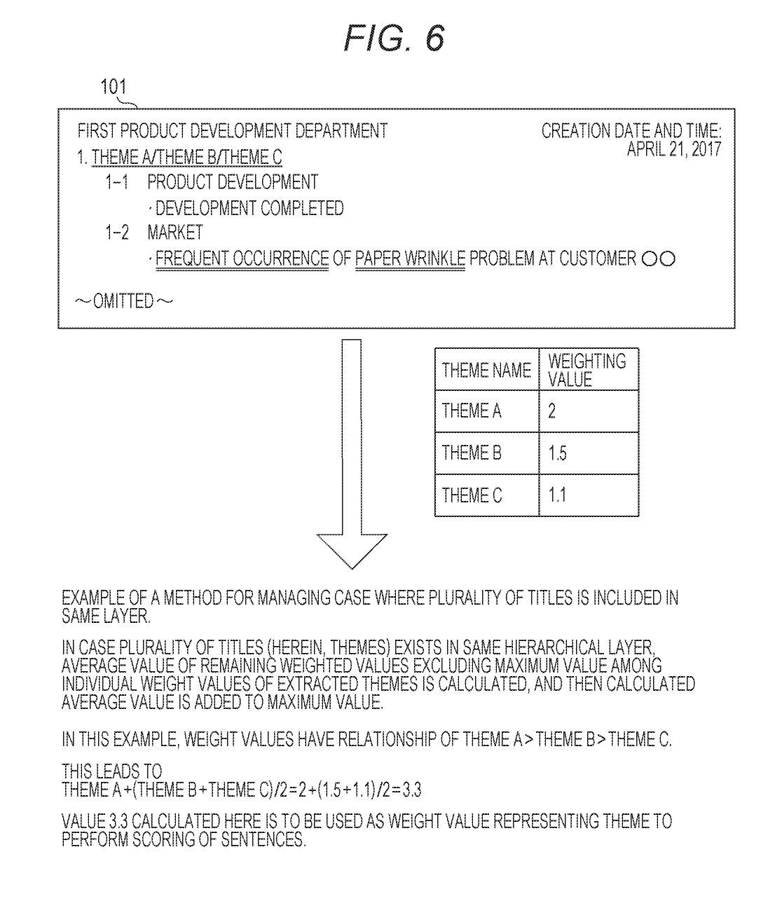

FIG. 6 illustrates an example of a method for managing a case where a plurality of titles is included in the same layer. In the document 101 of FIG. 6, three themes (theme A, theme B, theme C) are described in parallel as titles of the same hierarchical layer, and each of sentences located in a lower layer of the theme is discriminated to belong to all of the three themes arranged in parallel.

In such a case, first an average value of remaining weighted values excluding the maximum value among the individual weight values of the extracted themes (theme A, theme B, theme C) is calculated. Subsequently, this average value is added to the maximum value and the result of this is to be adopted as a weight value representing these titles.

In this example, the weight values have a relationship of theme A>theme B>theme C, and thus, the following expression is applicable.

Theme A+(theme B+theme C)/2=2+(1.5+1.1)/2=33.

The value 3.3 calculated here is to be used as a weight value representing the theme name to perform scoring of the sentences. While the embodiment of the present invention uses such a countermeasure, the method to manage the case where a plurality of titles is included in the same hierarchical level is not limited thereto.

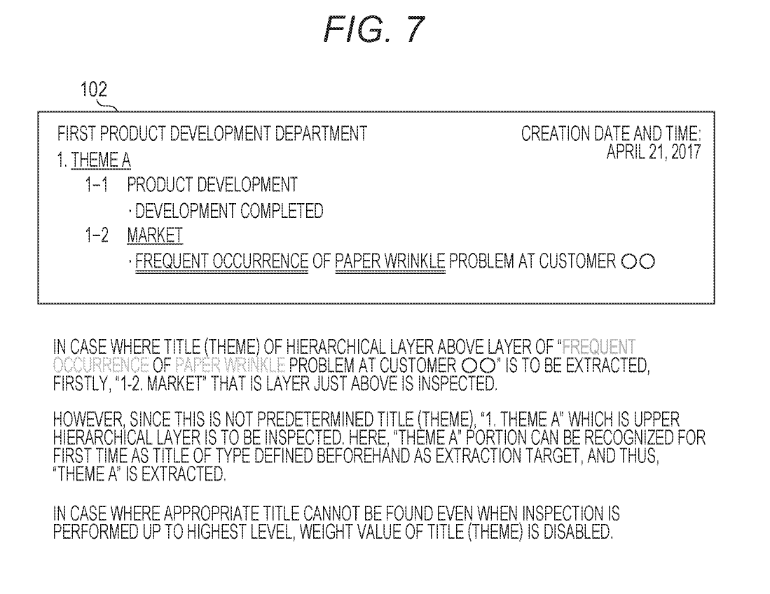

In FIG. 5, titles of two hierarchical layers of theme name and phase are used as titles of hierarchical layers above the hierarchical layer at which sentences as scoring target are located. In contrast, referring to FIG. 7, a case where simply a title of one hierarchical layer is used in scoring will be described.

FIG. 7 illustrates an example of an extraction method in the case of extracting simply the title of one hierarchical layer among the titles of hierarchical layers above the hierarchical layer at which a sentence is located. In the embodiment of the present invention, the title type as an extraction target is determined beforehand, and the title is extracted only in a case where the title of this type exists.

In FIG. 7, the title of the hierarchical layer above the hierarchical layer at which the sentence “Frequent occurrence of paper wrinkle problem at customer ∘∘” exists in the document 102 is extracted. The title type as an extraction target is assumed to be the theme name. Firstly, “1-2 Market” at the same level as the sentence is inspected. However, since “1-2” or “market” is inappropriate as the content of the predetermined type (theme name), the title of “1. Theme A” which is the upper hierarchical layer is to be inspected. Here, the “theme A” portion can be recognized for the first time as the title of the type defined beforehand as an extraction target, and thus, “theme A” is extracted. In a case where an appropriate title cannot be found even when inspection is performed up to the highest level, the scoring of the sentence is performed such that extraction of a specific type of title is not successful.

In this manner, the type of the title to be used for scoring may be determined beforehand, or the title of the hierarchical layer closer to the hierarchical layer to which the sentence belongs may be prioritized among the hierarchical layers above the hierarchical layer to which the sentence belongs. For example, when there is a title in the hierarchical layer to which the sentence belongs, a weight value corresponding to the title is derived. When there is no title, the presence or absence of the title the hierarchical layer immediately above is examined. When there is a title there, a weight value corresponding to the title is derived. When there is no title, the presence or absence of the title of the next higher hierarchical layer is examined. In this manner, the title of the closest hierarchical layer in a hierarchical layer above the hierarchical layer to which the sentence belongs may be used for scoring.

Alternatively, in the case of performing scoring on the basis of titles of a plurality of hierarchical layers, it is allowable to total the weight value of the title of the closest hierarchical level and the weight value of the title of the next closest hierarchical level with respect to the hierarchical layer to which the sentence as a scoring target belongs, with weights corresponding to the order how close to the target layer (priority order).

After completion of scoring by using one keyword or title toward a sentence, the matter indicated by the sentence is specified, and at the same time, the duration of that matter is acquired, and then, a final weight value (final score) of the sentence is calculated by using the weight value corresponding to the acquired duration. First, a method of identifying matters will be described.

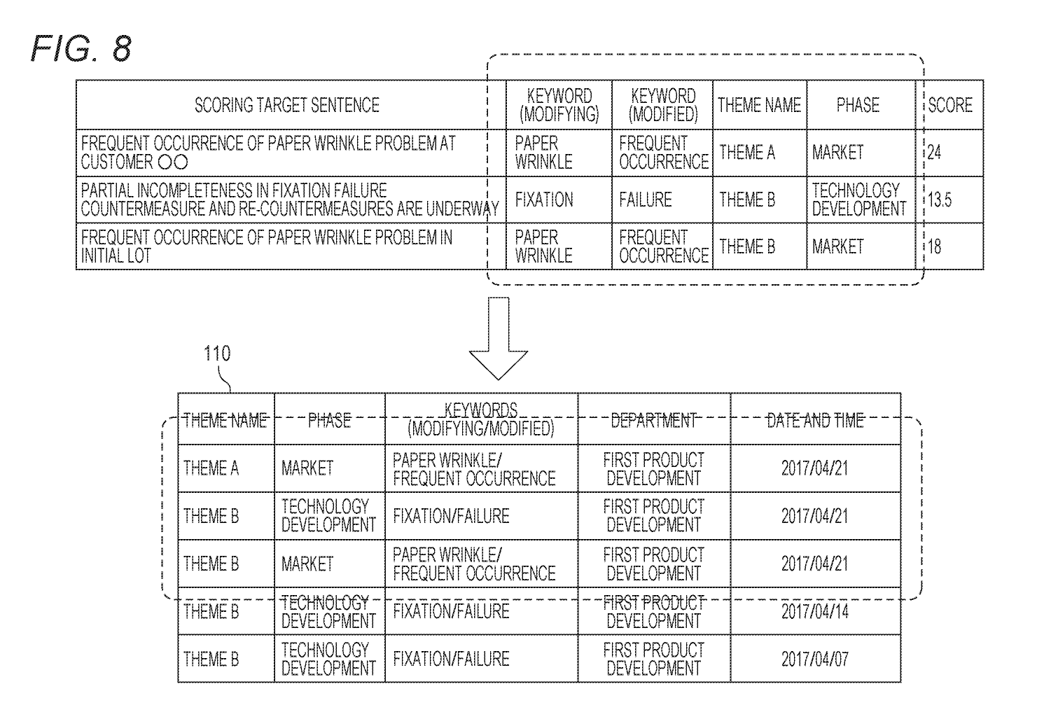

In a case where scoring is performed with a keyword or a title, the server 10 registers a combination of the keyword, the title, various types of information related to the sentence, or the like, used for the scoring as scoring history in association with the creation date and time of the scored sentence. The scoring history functions as a sentence creation history in the present invention. Various types of information related to the sentences are assumed to be the department name. The server 10 specifies the matters indicated by the sentences by using the combination of the registered keywords, themes, phases, and department names. FIG. 8 illustrates a state in which the matters indicated by the sentences are stored in a scoring history 110 on the basis of the result of scoring performed in FIG. 5.

The department name and the date and time in the scoring history 110 are acquired from a header, a footer, character strings in a specific region in the document, the property of the document, the file name, the file information, or the like. Acquisition of these may be performed by other methods. For example, when a sentence is extracted from a document 100 of FIG. 3, the content of each of extracted sentences is analyzed so as to acquire the department name and creation date and time from sentence 1.

In a case of acquiring a duration for a matter indicated by a certain sentence, first examination is made whether there is a record in which all of “keyword”, “title (theme name, phase, and the like)” and “department name” in the scoring history match those of the sentence as a scoring target, and when there is a matching record, it is judged that the sentence indicated by the record and the sentence as a scoring target are sentences related to a common matter. Accordingly, a temporal difference between the date and time of the record having the oldest date and time out of the records having matters matching with the sentence as a scoring target and the creation date and time of the sentence as a scoring target is extracted, and this extracted difference is defined as the duration of the matter indicated by the sentence as the scoring target.

In the embodiment of the present invention, it is judged to be a record of the sentence indicating the matter common to the sentence as the scoring target only in a case where all the combinations of“keyword”, “title (theme name, phase, and the like),” and “department name” are perfectly matched. However, it is also allowable to judge that it is a record of the sentence indicating the common matter in a case where at least a part of the combinations achieves a match (for example, in a case where the “keyword” and “title” match).

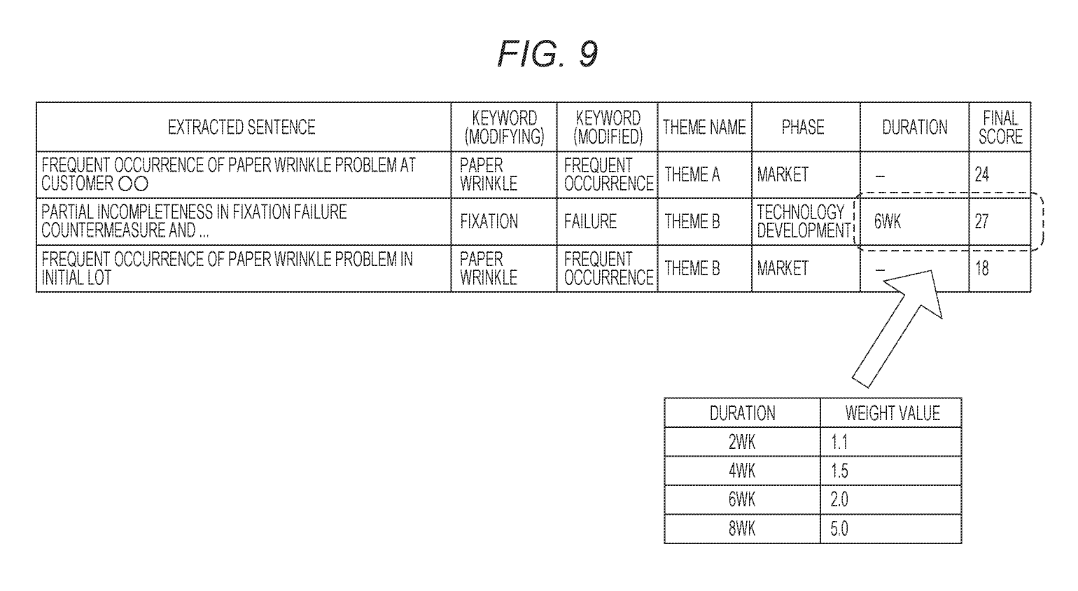

In the embodiment of the present invention, a weight value corresponding to the duration is preliminarily set FIG. 9 illustrates three sentences, the matters indicated by the sentences, the durations, and the final scores, in a table. FIG. 9 further illustrates a table of weight values according to duration.

In FIG. 9, the duration of the matters (matters specified in fixation, failure, theme B, technology development, or first product development) indicated by the sentence “Partial incompleteness in fixation failure countermeasure” is six weeks (written as 6WK in the figure) (corresponding to 2017 Mar. 10 to 2017 Apr. 21; refer to FIG. 8). The matters indicated by the other two sentences have no duration.

Regarding the sentence concerning a matter having a duration, a score calculated on the basis of a keyword or a title is multiplied by a weight value according to the duration so as to calculate a final score. In FIG. 9, the weight value corresponding to the case where the duration is six weeks is 2.0. Accordingly, “27” obtained by multiplying the score (13.5, refer to FIGS. 5 and 8) calculated on the basis of the keyword or title by 2.0 is defined as a final score. For those without a duration, a value calculated by multiplying the score calculated on the basis of keywords or titles by one is defined as the final score.

Next, a case where a matter which has been completed once in the past occurs again will be described. First, the server 10 presets and saves character strings such as “completion”, “completed”, “closed”, and the like, for discriminating whether the matter indicated by the sentence is completed or not. When an expression indicating completion is detected in the sentence at the time of scoring the sentence, information indicating that the matter is completed is also registered to the scoring history at a registration of the matter indicated by the sentence.

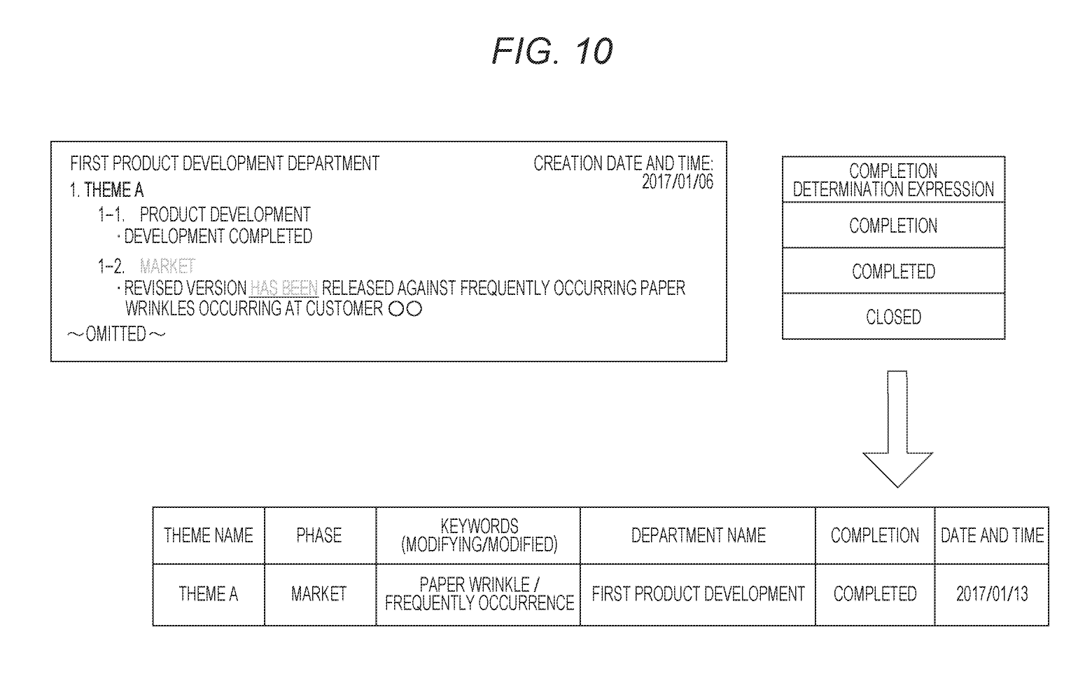

FIG. 10 illustrates an example of registering the completion of the matter in the scoring history together. Here, a character string of “completed” has been found in the sentence “a revised version has been released against frequently occurring paper wrinkles occurring at customer ∘∘”, and thus, a message of “completed” is also registered in the scoring history in addition to “keyword” “(theme name, phase, and the like)” and “department name”.

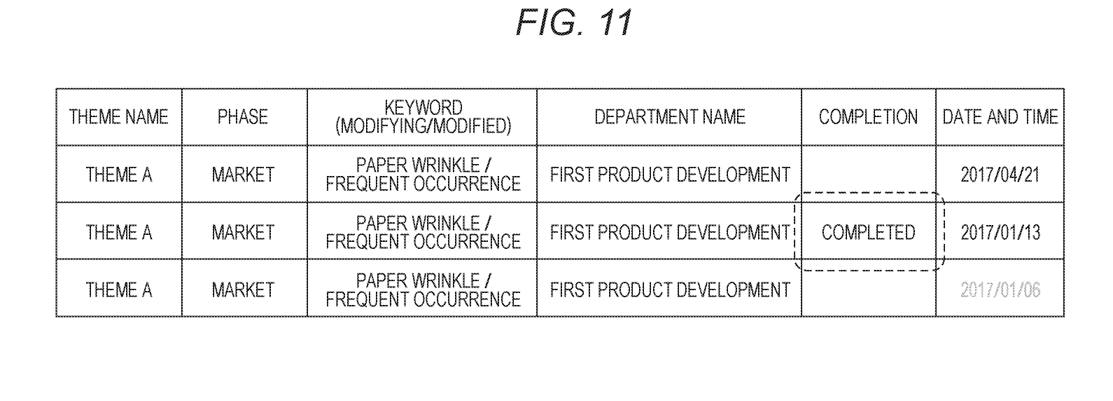

Next, a method of acquiring the duration of a matter in view of the above-described “completed” record will be described. FIG. 11 illustrates three records related to matters specified by “theme A, market, paper wrinkle, frequent occurrence, and first product development” among the scoring history. The date and time of the three records are “2017/01/06”, “2017/01/13”, and “2017/04/21”. Moreover, the record of “2017/01/13” has recorded that the matter has been completed.

In FIGS. 8 and 9, the duration is calculated on the basis of the temporal difference between the oldest record and the creation date and time of the sentence as a scoring target out of the records having the same matters among the scoring history. However, in a case where the completed record exists, the duration would be calculated on the basis of the recording of the date and time after completion alone.

In FIG. 11, since the matter has been completed in the recording of “2017/01/13”, the previous recordings (“2017/01/13” and “2017/01/06”) are excluded, and then, a temporal difference between “2017/04/21” oldest among the subsequent records and the present is used to calculate the duration. For example, in the case of newly scoring a sentence illustrating the same matter as in the record of FIG. 11, and when the date and time is “2017/05/21”, it is judged that the duration is four weeks”. Note that when there is no record after the completed record, the duration is “0” on the assumption that the condition has not occurred.

Next, a case where scoring is performed in view of the number of times of recurrence of a matter will be described. In the case of a record of a sentence indicating a matter common to the matters indicated by the sentence and in a case where the record indicating completion is registered in the scoring history, the number of completed records is regarded as the number of times of recurrence of the matter, and the number or records completed is multiplied by a coefficient corresponding to the number of times of recurrence, at the time of calculating the final score.

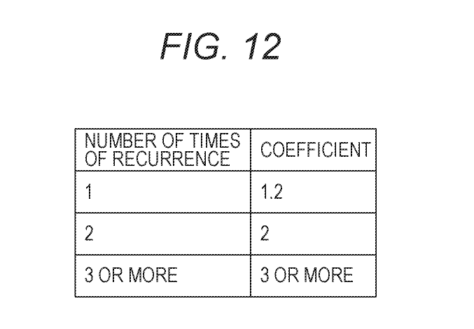

When the number of completed records is one, the number of times of recurrence is set to once, and when the number of completed records is two, the number of times of recurrence is set to twice. FIG. 12 illustrates the number of times of recurrence and a coefficient corresponding to the number of times of recurrence. In a case where the number of times of recurrence is one, the coefficient is 1.2, in a case where the number of times of recurrence is two, the coefficient is 2, and in a case where the number of times of recurrence is three or more, the same number as the number of times of recurrence would be the coefficient.

For example, since the same matter has already been completed once at the time of creating a sentence related to the record of “2017/04/21” in FIG. 11, the number of times of recurrence would be one, and the final score is a value obtained by multiplying the numerical value calculated by the method described in FIG. 9 by the coefficient 1.2.

In this manner, the server 10 performs scoring on the sentence and calculates the final score. Scoring is performed in view of not only keywords in the sentences but also the title of the hierarchical layer above the hierarchical layer at which the sentence is located, the duration of the matters indicated by the sentences, and the number of times of recurrence. Accordingly, it is possible to perform scoring to fit the actual situation compared with the case of performing scoring simply using the keywords in the sentence.

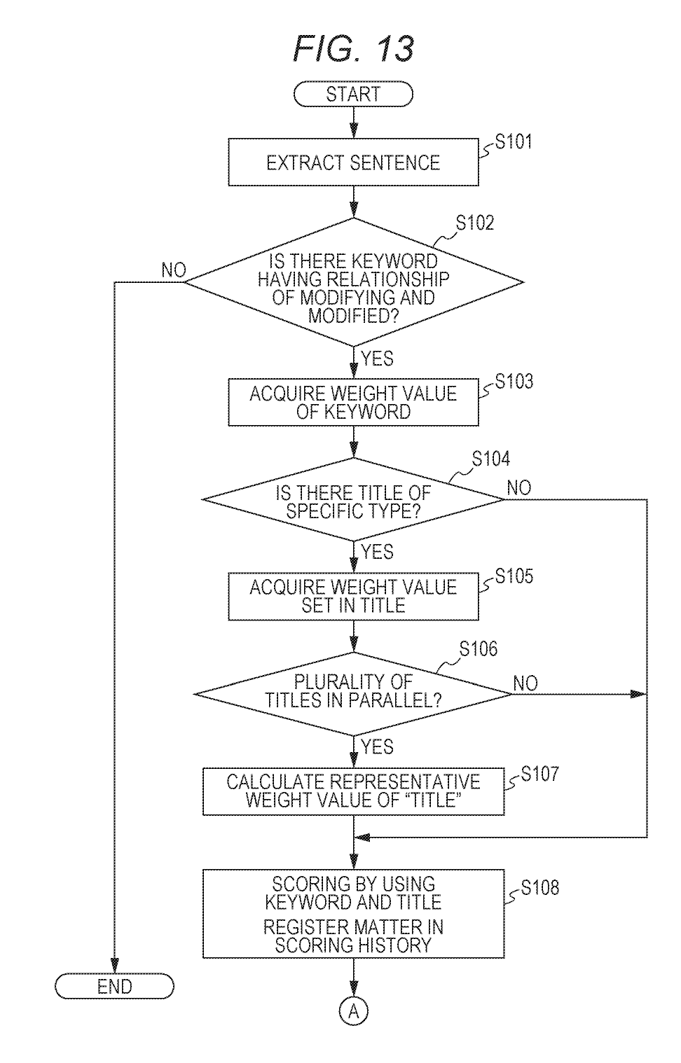

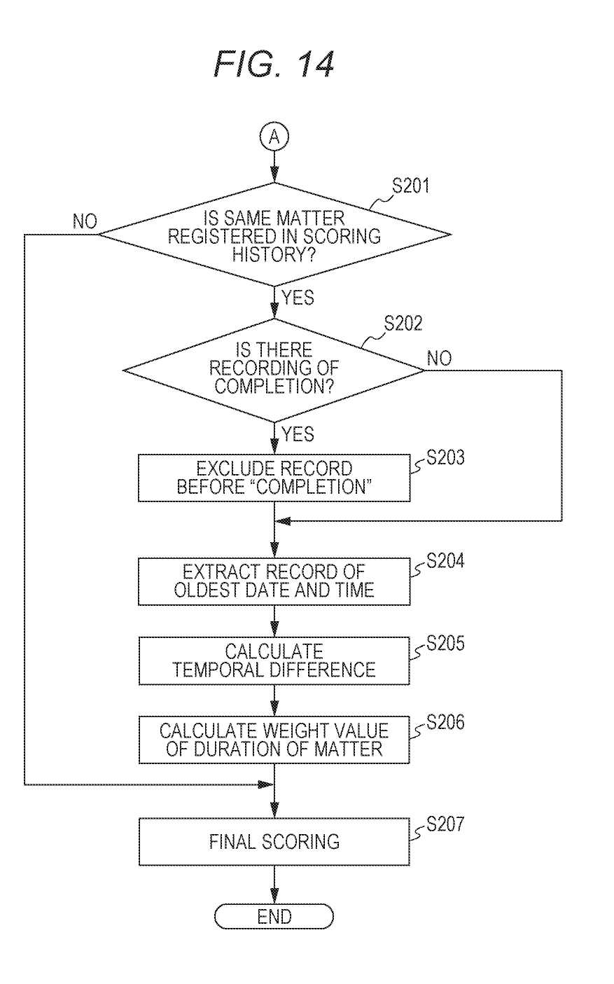

Next, a flow of processing performed by the server 10 according to the embodiment of the present invention will be described. FIGS. 13 and 14 are flowcharts illustrating the flow of the processing executed by the server 10 when it performs the scoring of the sentence. FIG. 13 illustrates a processing flow of scoring based on keywords and titles. FIG. 14 illustrates a processing flow of calculating the duration of matters so as to calculate the final score.

First, in step S101 of FIG. 13, a sentence is extracted from a document by the method described in FIG. 3. In a case where there are no two keywords having a modifying-modified relationship among the extracted sentences (step S102; No), the processing is finished. In a case where there are two keywords having the modifying-modified relationship among extracted sentences (step S102; Yes), a weight value of the keyword is acquired (step S103).

Next, examination is performed so as to whether there is a title of a predetermined type such as “theme name” in the title of the hierarchical layer above the hierarchical layer at which the sentence is located (step S104). In a case where there is no title of a predetermined type (step S104; NO), the processing proceeds to step S108. In a case where there is a title of a predetermined type (step S104; Yes), the weight value preset in the title is acquired (step S105).

In a case where the number of the titles detected in step S104 is singular (step S106; No), the processing proceeds to step S108. In a case where the plurality of titles is detected in step S104 in parallel (step S106; Yes), the weight values representing the plurality of titles are calculated by the method described in FIG. 6 (step S107).

In step S108, scoring is performed with the keywords and titles by using the calculation method described with reference to FIG. 5, and at the same time, a combination of the keywords, the titles, or the like are defined as the matter indicated by the sentence, and then, a record associating the matter and the creation date and time of the sentence is created and registered in the scoring history.

When registering a matter indicated by a sentence in the scoring history, as described in FIG. 8, other information such as the department name may be associated and registered as an element that specifies the matter. After registering the scoring history, the processing proceeds to step S201 in FIG. 14.

In step S201 of FIG. 14, a record of a matter common to the matter registered in step S108 is extracted from the scoring history (step S201). When there is no record of common matters with the matters registered in step S108 (step S201; No), the processing proceeds to step S207.

After a record of a common matter is extracted (step S201; Yes), examination is made as to whether there is a completed record (step S202).

In a case where there is a completed record (step S202; Yes), the record before the completion is excluded (step S203), and the processing proceeds to step S204. In a case where there is no completed record (step S202; No), the processing proceeds to step S204.

In step S204, the record with the oldest date and time is extracted from the extracted records. In a case where the record before completion has been excluded in step S203, the record with the oldest date and time would be extracted from the remaining records. Thereafter, a temporal difference between the date and time of the extracted record and the present is calculated (step S205), and the weight value of the duration of the matter indicated by the sentence as a scoring target is acquired from the calculation result (step S206).

Thereafter, the final score is calculated from the score calculated in step S108 of FIG. 13 and the weight value of the duration acquired in step S206 by using the method described in FIG. 9 (step S207), and then, the present processing is finished.

In addition, in step S104 of the flow of FIG. 13, a character string related to completion is searched in addition to the title. In a case where a character string concerning completion is detected here, information indicating that the matter indicated by the sentence has been completed is also registered in performing registration to the scoring history in step S108.

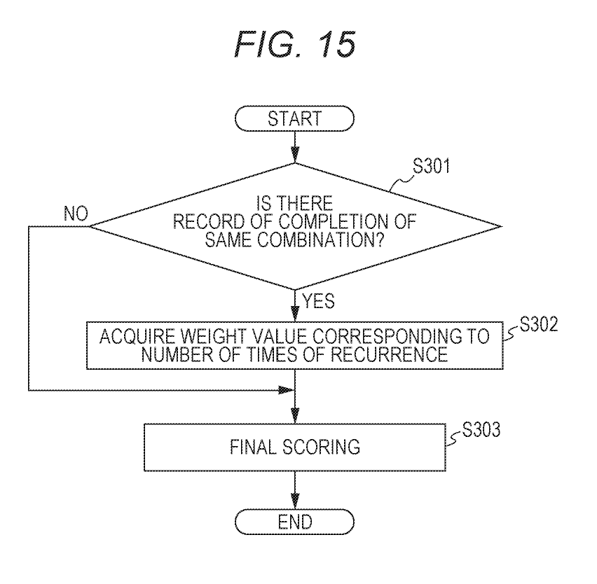

FIG. 15 illustrates a flow in the case where the number of times of recurrence is in view. First, it is examined whether there is a completed record in the records extracted from the scoring history in step S201 (step S301). In a case where there is no completed record (step S301; No), the processing proceeds to step S303.

In a case where there is a completed record (step S301; Yes), a weight value (coefficient) corresponding to the number of completed records (number of times of recurrence) is acquired (step S302), and then, the acquired weight value is multiplied with the final cored calculated in step S207 to re-calculate the final score (step S303), so as to finish the current processing.

Note that the processing in FIGS. 13 to 15 is assumed to be repeatedly performed for each of sentences detected from the document.

Although the embodiments of the present invention have been described with reference to the drawings, specific configurations are not limited to those illustrated in the embodiments, and modifications and additions within the scope not deviating from the spirit of the present invention are also to be included in the present invention.

In the embodiment of the present invention, the server 10 has functions as the sentence scoring apparatus of the present invention, but the sentence scoring apparatus is not limited thereto. For example, other devices such as the PC 5 or an MFP may serve as the sentence scoring apparatus.

The method of extracting sentences from documents and the method of extracting keywords, titles or the like are not limited to those described in the embodiment of the present invention. Moreover, keywords, titles or the like are not limited to those described in the present invention. The calculation formula for scoring is not limited to that described in the embodiment. While the embodiment of the present invention uses the preset weight values (coefficients) of the keyword, the title, the duration, the number of times of recurrence or the like, they may be changeable by the user.

The method of acquiring the duration is not limited to the method described in the embodiment of the present invention. For example, the duration may be acquired by inquiring to another server or the like in which the situation of the matter indicated by the sentence is recorded. Further, the method of specifying the matter is not limited to the method described in the embodiment of the invention. A keyword other than the keyword related to the scoring may be used or a combination may be used to specify the matter, or a keyword or a theme used for scoring may partially be specified by a combination of elements.

In the embodiment of the present invention, scoring is performed in view of the duration of a matter indicated by a sentence. However, scoring of the sentence may be performed only with the use of the title of the hierarchical layer above the hierarchical layer at which the keyword and the sentence are located.

In the embodiment of the present invention, the type of the title of the hierarchical layer above the hierarchical layer at which the sentence is located is “theme name”, “phase”, or the like. However, it is allowable to use a “product name”, a “project name”, a “negotiation name”, a “department name”, “information of person in charge”, “creation date”, or the like. It suffices to include one of them.

A duration of a matter indicated by a sentence may be acquired using a sentence creation history different from the scoring history. This creation history may be any database as long as it can specify the creation date and matters of documents and sentences that have been created so far.

Although the embodiment of the present invention is a case where the longer the duration, the larger the weight value, it is allowable to configure such that the shorter the duration, the larger the weight value. Alternatively, the weight value may be increased as the duration becomes longer while the duration is less than a predetermined period, and the weight value may be decreased as the duration becomes longer in a case where the duration exceeds a predetermined period (that is, the weight value may be lowered in case of a prolonged and constant state). Furthermore, the relationship between the duration and the weight value may be set to any setting such that the weight value rapidly changes at a point after exceeding a certain period of time.

Although embodiments of the present invention have been described and illustrated in detail, the disclosed embodiments are made for purposes of illustration and example only and not limitation. The scope of the present invention should be interpreted by terms of the appended claims.

What is claimed is:

1. A sentence scoring apparatus comprising
a hardware processor that:
extracts a sentence from a document having a hierarchical structure;
derives a first weight value corresponding to a title of a hierarchical layer above a hierarchical layer to which the sentence extracted by the hardware processor belongs;
extracts a keyword included in the sentence;
derives a second weight value of the sentence on the basis of the extracted keyword; and
determines a weight value of the sentence on the basis of the first weight value and the second weight value.

2. The sentence scoring apparatus according to claim 1,
wherein the hardware processor derives the first weight value starting preferentially from a title of a hierarchical layer closer to a hierarchical layer to which the sentence belongs, out of hierarchical layers above the hierarchical layer to which the sentence belongs.

3. The sentence scoring apparatus according to claim 1,
wherein the keyword is a character string indicating a risk.

4. The sentence scoring apparatus according to claim 1,
wherein the hardware processor determines a weight value of the sentence only in a case where the hardware processor derives the second weight value on the basis of the two keywords in a modifying-modified relationship, extracted from the sentence.

5. The sentence scoring apparatus according to claim 1,
wherein the title includes at least one of “product name”, “project name”, “theme name”, “phase”, “negotiation name”, “department name”, “information of person in charge”, or “creation date”.

6. The sentence scoring apparatus according to claim 1,
wherein, in a case where there is a plurality of titles in a same hierarchical layer, the hardware processor derives the second weight value on the basis of a weight value preset for each of the plurality of tides.

7. A non-transitory recording medium storing a computer readable program causing an information processing apparatus to operate as the sentence scoring apparatus according to claim 1.
